(19) United States
(12) Patent Application Publication
(10) Pub. No.: US 2014/0052621 A1
(43) Pub. Date: Feb. 20, 2014

(54) MERCHANT ELECTRONIC CHECK PAYMENTS

(71) Applicant: AP TECHNOLOGY, LLC, Carlsbad, CA (US)

(72) Inventor: Richard Love, Carlsbad, CA (US)

(73) Assignee: AP TECHNOLOGY, LLC, Carlsbad, CA (US)

(21) Appl. No.: 14/045,755

(22) Filed: Oct. 3, 2013

Related U.S. Application Data
(63) Continuation-in-part of application No. 13/573,795, filed on Oct. 3, 2012.
(60) Provisional application No. 61/542,625, filed on Oct. 3, 2011.

(51) Int. Cl. G06Q 20/26

(52) U.S. Cl. CPC G06Q 20/26
USPC 705/39

(57) ABSTRACT

Systems and methods are provided for causing a computing device to process a check payment from a user using a debit card by: receiving debit card information from the user; sending the information to a payment platform via a network connection; exchanging the debit card information with an ATM network at a bank and receiving a response including a bank account and a bank routing number; making a fraud potential determination; returning a success flag if fraud is not suspected and an error message if fraud is suspected; storing the returned bank account and bank routing number in a database if fraud is not suspected; requesting the user to write their signature on a digitization pad in operation and storing the signature in the database; and creating a check image.

### CROSS REFERENCE TO RELATED APPLICATIONS

This application is a continuation-in-part of U.S. patent application Ser. No. 13/573,795, filed on Oct. 3, 2012, which claims priority to U.S. Provisional Patent Application No. 61/542,625, filed Oct. 3, 2011, the contents of which are incorporated herein in their entireties.

### FIELD OF THE APPLICATION

The present application relates generally to virtual checking, and more particularly to systems and methods for providing merchant electronic check payments.

### DESCRIPTION OF THE RELATED ART

Conventional paper check payments suffer from a number of disadvantages. The reliance on US Mail and courier services to deliver checks inhibits the usage of checks for same day or inner day payments for all but a small percentage of check payments. In addition, paper checks are also easily forged and altered. Furthermore, paper checks consume valuable resources including energy, paper and toner. Alternatives to paper checking also suffer from a number of disadvantages. By way of example, traditional electronic payments require the Payee to share banking information with the Payor, which requires a trusted relationship. Additionally, ACH payments take days to process and weeks to set up initially. ACH payments are commonly followed by remittance information being printed and mailed to the Payee. Another alternative is the use of wire transfers, which are fast, but are very costly to use.

There is a recent trend whereby more merchants are moving to accepting only cash for goods and services. This dramatic change is in response to discontent with credit card and debit card processing rules and fees. In particular, credit card payments cost merchants 2.5%-5% of every transaction, plus minimum transaction fees. These fees can reduce a merchants bottom line profits by 10-20%. On closer inspection, another factor is becoming a larger issue for some merchants, namely bank or card processor reversals. When accepting credit card payments, merchants are subject to payment reversals anywhere from 30 days to 2 years after the transaction was initially posted, regardless if the service was already rendered or if the goods were successfully returned to the merchant. This creates lingering liabilities for merchants. Moreover, these reversals have been increasing in frequency in recent years.

### BRIEF SUMMARY OF EMBODIMENTS OF THE APPLICATION

Embodiments of the invention are directed toward systems and methods are provided for causing a computing device to process a check payment from a user using a debit card by: receiving debit card information from the user; sending the information to a payment platform via a network connection; exchanging the debit card information with a financial services provider and receiving a response including a bank account and a bank routing number; and optionally making a fraud potential determination; returning a success flag if fraud is not suspected and an error message if fraud is suspected; storing the returned bank account and bank routing number in a database if fraud is not suspected; requesting the user to write their signature on a digitization pad in operation and storing the signature in the database; and creating a check image.

Other features and aspects of the application will become apparent from the following detailed description, taken in conjunction with the accompanying drawings, which illustrate, by way of example, the features in accordance with embodiments of the application. The summary is not intended to limit the scope of the application, which is defined solely by the claims attached hereto.

### BRIEF DESCRIPTION OF THE DRAWINGS

The present application, in accordance with one or more various embodiments, is described in detail with reference to the following figures. The drawings are provided for purposes of illustration only and merely depict typical or example embodiments of the application. These drawings are provided to facilitate the reader's understanding of the disclosure and shall not be considered limiting of the breadth, scope, or applicability of the disclosure.

FIGS. 1 and 2 are flow diagrams illustrating a process of making a check payment using a debit card.

FIG. 3 is a flow diagram illustrating a high-level method for providing check payments from one person to another person or business without using a paper check.

FIGS. 4A-4D are tables comparing traditional check processes and the corresponding electronic check processes described herein.

FIG. 5 is a pair of flow diagrams depicting a traditional method for check payment processing and a method for electronic virtual check payment processing.

FIG. 6 is a diagram illustrating an electronic virtual check payment system in accordance with an embodiment of the invention.

FIG. 7 is a bank check image having a generic check background.

FIG. 8 is a table depicting various information of the Payor.

FIG. 9 is an image of an electronic virtual check created by merging the bank check of FIG. 7 with the Payor information of FIG. 6, in accordance with the various systems and methods for electronic virtual checks set forth herein.

FIG. 10 is a diagram illustrating a person-to-person payment method and system using the electronic virtual checks described herein, in accordance with an embodiment of the invention.

FIG. 11 is a diagram illustrating the conversion of a paper check into an electronic virtual check for delivery and deposit, in accordance with an embodiment of the invention.

FIG. 12 is a diagram depicting a person-to-business payment method and system using electronic virtual checks, in accordance with an embodiment of the invention.

FIG. 13 is a diagram illustrating a business-to-business payment method and system using electronic virtual checks, in accordance with an embodiment of the invention.

FIG. 14 is a diagram illustrating another business-to-business payment method and system using electronic virtual checks, in accordance with an embodiment of the invention.

FIG. 15 is a diagram illustrating an additional business-to-business payment method and system using electronic virtual checks, in accordance with an embodiment of the invention.

FIG. 16 is a diagram illustrating a system and method for depositing Payee eVCs, in accordance with an embodiment of the invention.

FIG. 17 is a diagram illustrating an example computing module for implementing various embodiments of the invention.

These figures are not intended to be exhaustive or to limit the application to the precise form disclosed. It should be understood that embodiments of the application can be practiced with modification and alteration, and that the application be limited only by the claims and the equivalents thereof.

### DETAILED DESCRIPTION OF THE EMBODIMENTS OF THE APPLICATION

Embodiments of the present application are directed toward systems and methods for providing check payments from one person to another person or business without using a paper check. Further embodiments are directed toward systems and methods for providing check payments from one business to another business, or from a business to a person, without using a paper check.

As used herein, an electronic virtual check (“eVC”) may also be referred to as an electronic draft or a draft for making certain payments without the use of paper. Embodiments of the invention are directed toward systems and methods for making merchant electronic draft payments, as well as electronic draft payments that are business-to-business, business-to-consumer, consumer-to-business, or consumer-to-consumer. Further embodiments are directed toward systems and methods for making deposits directly from electronic drafts, without check conversion. Other embodiments described systems and methods for creating electronic drafts, for managing signatures and approvals for electronic drafts, for making instant payments that reduce physical delivery requirements. Some such embodiments may feature integration with Positive Pay and/or certain security features described herein.

Some embodiments of the invention are directed toward providing a payment solution for merchants. Specifically, the proposed solution provides a middle ground between traditional check payments and credit card payments by introducing check payments using a debit card. Of course, checks are not subject to unilateral reversals initiated by banks. By contrast, refunds for check payments are at the discretion of the merchant. Although checks can be processed at a far lower cost than cards, it is difficult for merchants to persuade consumers to go back to checks.

Checks were the major payment instrument in years past. Over the last decade, they have been nearly completely replaced at point of sale transactions by credit and debit cards. Today consumers rarely carry checks, and if they do, the extra time in the checkout line to write the check is noticed and received with disdain. Checks, however, provide an excellent middle ground between the inconvenience and security risk of carrying cash and the costs of cards.

Embodiments of the invention allow consumers to write a check by merely swiping their debit card, and providing an electronic signature. The debit card account number (and optionally PIN) can be used to obtain an account balance inquiry (optional) and retrieve the checking account information (bank name, account and routing information). This information is then combined with the consumers digital signature and then transformed into an eVC comprising an image of a check which meets Check 21 standards. During the creation of the eVC, the checking account information is sent to a software service that manages eVC checks. The software service uses the information to do a lookup in a master database to determine if the account has ever produced an eVC. If so, it retrieves the next eVC check number for that account to use on the eVC. However, if the account had never been used to create an eVC, then a “default” starting check number is assigned to the eVC. The eVC is electronically packaged and sent to the merchant's bank as a check deposit. This process enables the consumer to issue a check to the merchant without carrying their checkbook.

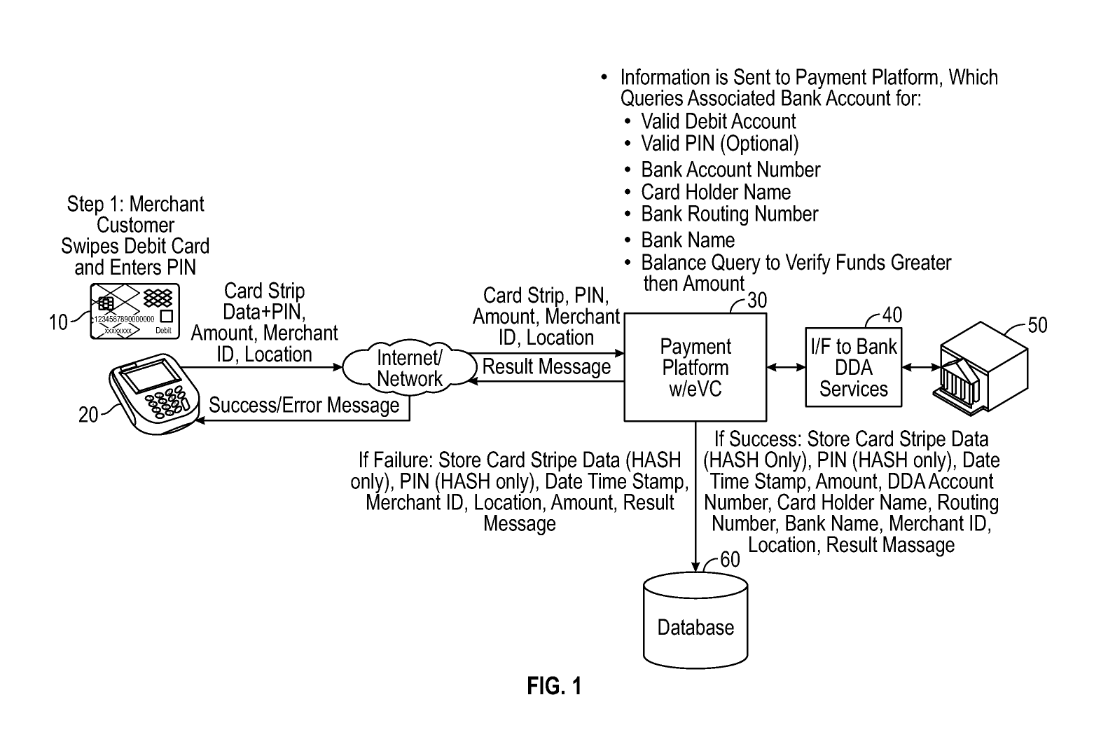

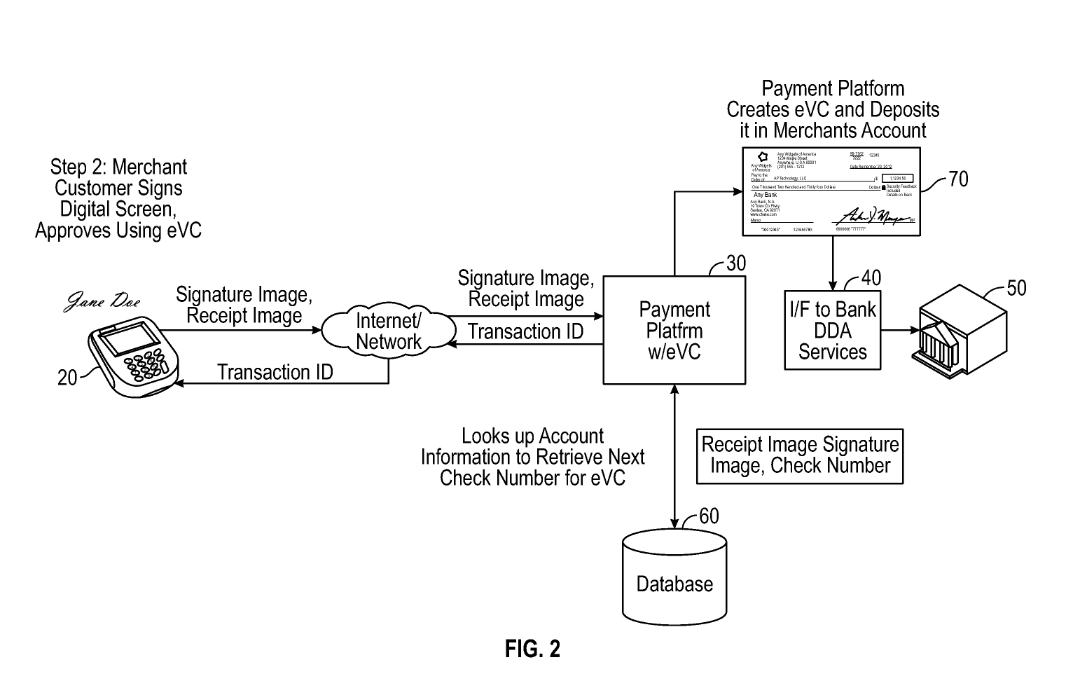

Referring to FIGS. 1 and 2, a process of making a check payment using a debit card 10 will now be described. Initially, operation 1 entails a merchant customer (referred to herein as “user”) swiping the debit card 10 on a card reader terminal 20. In one embodiment, the user is asked to enter their personal identification number (PIN) after swiping the debit card 10. In operation 2, the information read from the card (including the PIN if supplied, and optionally the amount of the transaction) is sent to a payment platform 30 via an Internet or network connection. In operation 3, the payment platform creates a query to a DDA server 40, which exchanges the debit card information (and PIN if supplied) with an financial services provider network 50 and receives a response including the bank account and the bank routing number. In additional, the response may optionally include the bank name and a validation if the supplied amount is less than the funds available. In some embodiments, the DDA server 40 makes a fraud potential determination, and returns a success flag if fraud is not suspected and an error message if fraud is suspected. The resulting bank account, bank routing number, bank name and success flag/error message are returned to the payment platform 30.

In operation 4, the payment platform 30 stores the returned account information in a database 60 if the DDA server 40 returns a success flag. Alternatively, if the DDA server 40 returns an error message, then operation 4 entails the payment platform 30 stores the error message in the database 60. In some embodiments, the payment platform 30 uses the data stored in the database 60 to make determinations on the likelihood of fraud. Fraud protections can be based upon prior fraudulent activity, the number of transactions within a given time period for a selected account as compared to normal values (velocity), unusual amounts, geographic locations of payments, or other history information. Once the information is stored in database 60 or fraud determination is rendered, then the results are queued for future forwarding to the card reader terminal 20. If an error message is returned from the payment platform 30, then the message can be used by the card reader terminal 20 to notify the merchant and/or handle the exception.

Referring now to FIG. 2, if the account lookup process is successful, then the user is asked to write their signature on a digitization pad in operation 5. In operation 6, this signature image is then sent (optionally along with the transaction receipt image) to the payment platform 30. In operation 7, the signature image is stored in the database 60, keyed to the card and account information, or optionally digitally compared against any previous signature images for the debit card for the purposes of fraud detection. In operation 8, the bank name, bank account information, check number, cardholder name, and signature are used by the payment platform 30 to create a check image (eVC 70). The bank account information, bank routing number and check number are printed at the bottom of the check to product a MICR line. In operation 9, the eVC is then sent to the bank 50 as a remotely deposited check (in Check 21 compatible format, ie: ×9.37, Image Cash Letter format). The check is then processed by the bank 50 as a check under REG CC guidelines.

From the perspective of the merchant, the eVC provides a discounted payment option, with no additional reversal liabilities than what is found with checks. Optionally, the merchant can query the account balance, thus determining whether sufficient funds are available and reducing the risk of collection.

From the perspective of the consumer, the eVC obviates the needs for credit cards and allows the consumer to pay for goods and services without requiring the time consuming process of writing checks. The merchant purchases and other eVC payments made by the consumer can be available through a web application as an online checkbook. It is envisioned that receipts for purchases can also be posted to the online application and referenced to the associated eVC check payment. These enhancements provide consumers with a convenient way to manage their checking account and keep track of receipts. It ultimately provides savings to the consumer by reducing credit card interest costs in that the merchant savings eventually results in lower costs for the services and goods.

According to further embodiments of the invention, the process of FIGS. 1 and 2 is extended to encompass online payments. Specifically, the process is revised to apply to an Online shopping cart experience, wherein the consumer completes transactions using an electronic signature. By way of example, the electronic signature can be scanned and uploaded by the consumer. Alternatively, a draft check can be created and used for electronic payments.

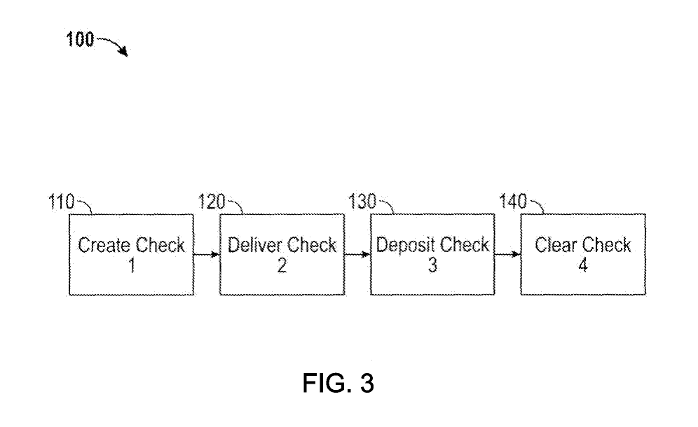

Referring to FIG. 3, a high-level method for providing check payments from one person to another person or business without using a paper check will now be described. The method 100 involves creating a check (operation 110), delivering the check (operation 120), depositing the check (operation 130), and clearing the check (operation 140). This electronic check payment process closely mimics the traditional paper check process. The primary difference lies in the creation and delivery of the payment instruments. Specifically, the electronic check payment process uses electronic check images rather than physical paper checks such that delivery can take place completely electronically across the Internet. This results in a reduction of costs by eliminating or reducing printing costs and mailing costs. Additionally, the checks can be delivered in real time.

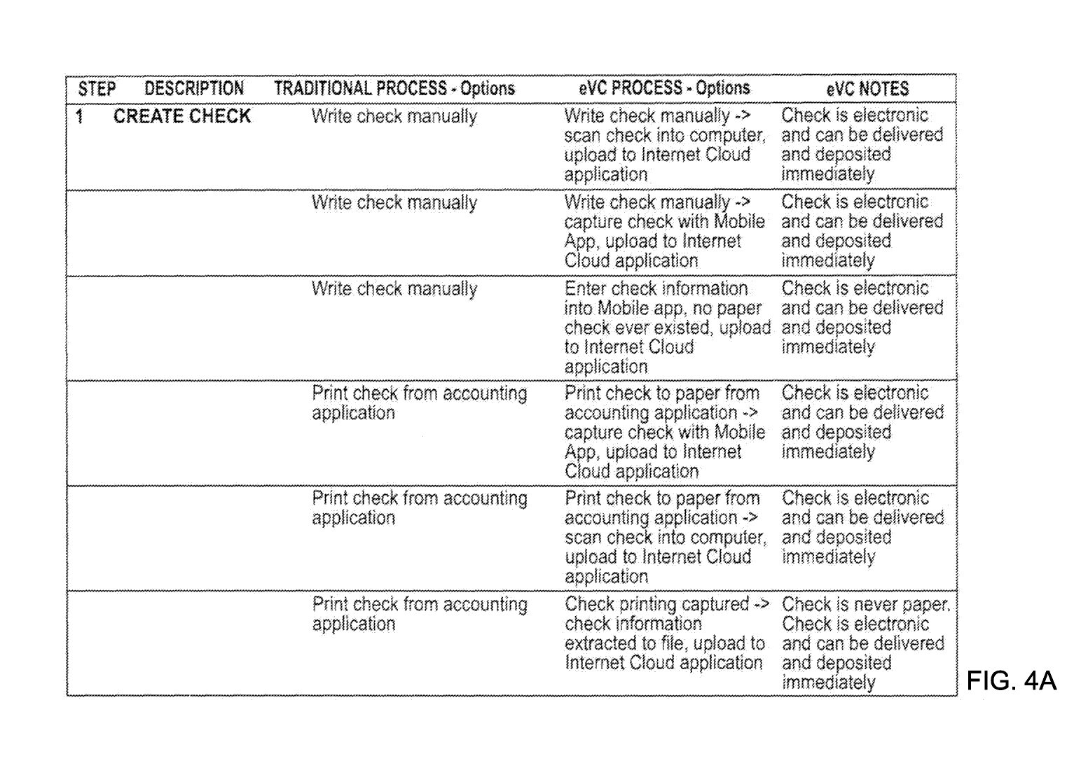

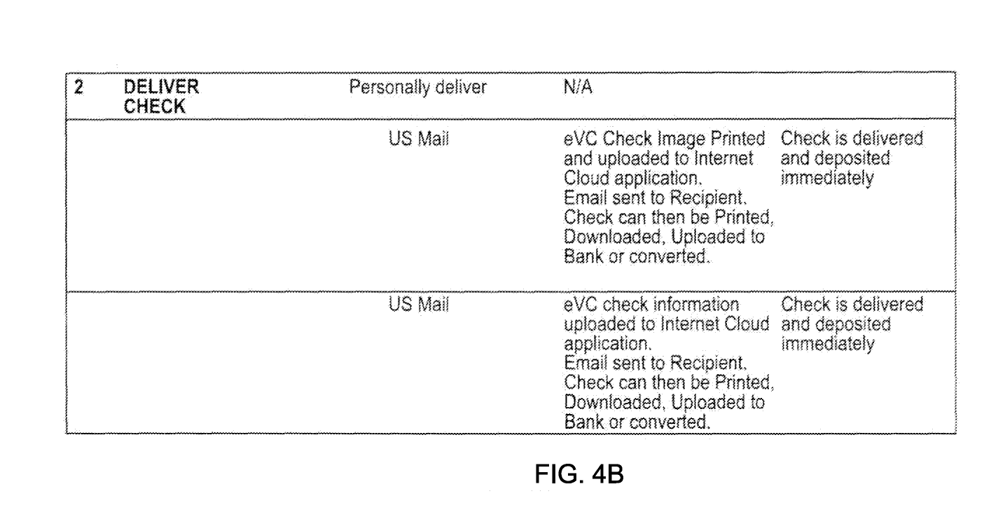

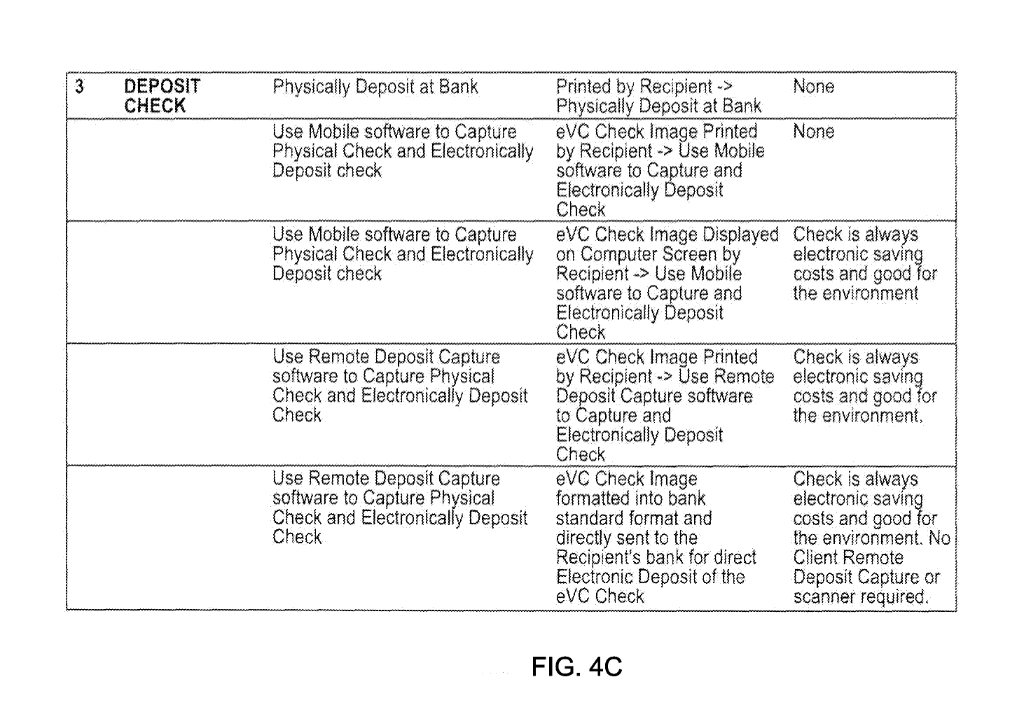

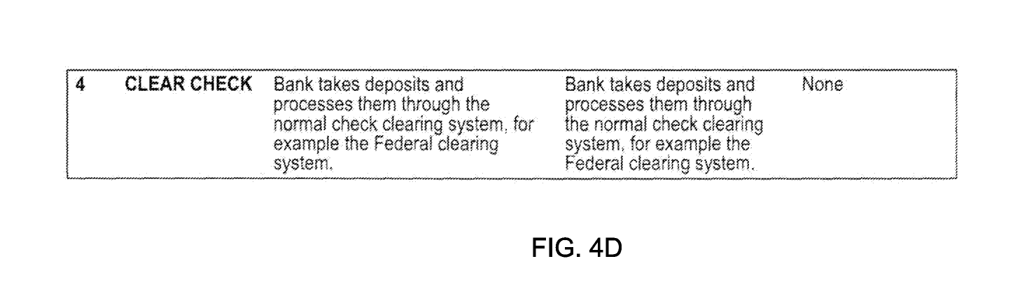

Similar to traditional checks, there are multiple options for performing each operation in the electronic check process (set forth in FIG. 3). FIGS. 4A-4D are tables providing a comparison between traditional check processes and the corresponding electronic check processes described herein.

Referring to FIG. 4A, a traditional process for creating a check may entail writing the check manually. According to an embodiment of the invention, a corresponding electronic virtual check creating process involves writing the check manually, scanning the check into a computer, and uploading the electronic check to an Internet cloud application. Another corresponding electronic virtual check creating process may involve writing the check manually, capturing the check using a mobile device application, and uploading the electronic check to an Internet cloud application. A further corresponding electronic virtual check creating process may involve entering the check information into a mobile device application and uploading the electronic check to an Internet cloud application. In each of these processes, the check is electronic and can be delivered and deposited immediately. In the latter process, no traditional check is even created.

With further reference to FIG. 4A, another traditional process for creating a check involves printing a check from a conventional accounting application. According to an embodiment of the invention, a corresponding electronic virtual check creating process involves printing the check to paper from a conventional accounting application, capturing the check with a mobile device application, and uploading the electronic check to an Internet cloud application. In this process, the check is electronic and can be delivered and deposited immediately. Alternatively, a corresponding electronic virtual check creating process may entail capturing the check electronically, extracting the necessary check information to a file, and uploading the electronic check to an Internet cloud application. In this case, the check is electronic (never printed) and can be delivered and deposited immediately. Another method may entail using a conventional accounting application to generate a payment file traditionally used to print paper checks.

Referring to FIG. 4B, a traditional check process for delivering a check might involve personal delivery (no corresponding eVC process) or by way of US Mail. According to an embodiment of the invention, a corresponding eVC process entails printing an image of an electronic virtual check and uploading it to an Internet cloud application. An email containing the notification of the eVC payment can be sent to the recipient. The eVC check can be downloaded from a cloud application and can then be printed, downloaded, uploaded to a bank, or converted. Alternatively, the eVC process may involve uploading the electronic virtual check information to a cloud application. An email containing the notification of the eVC payment is then sent to the recipient. The check can then be printed, downloaded, uploaded to a bank, or converted. In both processes, the electronic virtual check can be delivered electronically and deposited immediately.

Referring to FIG. 4C, a traditional check process for depositing a check may involve physically depositing the check at a bank. According to an embodiment of the invention, a corresponding electronic virtual check creating process involves the recipient of the eVC printing the check image and physically depositing it at a bank. Another corresponding electronic virtual check creating process involves using mobile a mobile device application to capture the physical check, and then depositing the check electronically. In an embodiment of the invention, a corresponding eVC process entails the recipient of an eVC image printing the check image, and then using a mobile device application to capture and electronically deposit the check. In another embodiment of the invention, a corresponding eVC process entails the recipient of an eVC image displaying the image on a computer screen, and using a mobile device application to capture and electronically deposit the check. In this case, the check is never printed, thereby provided a cost-saving and environmentally sensitive solution.

With further reference to FIG. 4C, another traditional check process for depositing a check may involve using a remote deposit capture application to capture a physical check and electronically depositing the check. In an embodiment of the invention, a corresponding eVC process entails the recipient of an eVC image printing the check image, and then using a remote deposit capture application to capture and electronically deposit the check. The check is always electronic using this process. In another embodiment of the invention, a corresponding eVC process entails the eVC image being formatted into the correct bank standard format and then sent to the recipient's bank for direct electronic deposit of the eVC check. In this case, the check is never printed, thereby provided a cost-saving and environmentally sensitive solution. Additionally, this process does not require the use of a scanner or client remote deposit capture software.

Referring to FIG. 4D, a traditional check process for clearing a check may involve the bank processing deposits through a conventional check clearing system such as the Federal clearing system. According to an embodiment of the invention, a corresponding electronic virtual check creating process likewise involves the bank processing deposits through a conventional check clearing system such as the Federal clearing system.

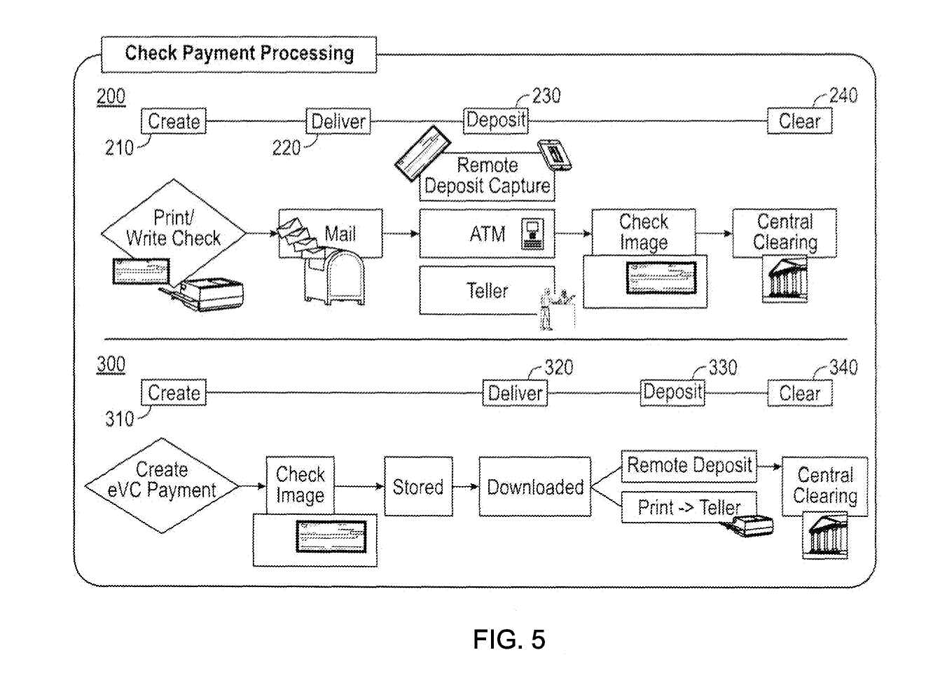

FIG. 5 illustrates a pair of flow diagrams depicting: (i) a traditional method for check payment processing 200, and (ii) a method for electronic virtual check payment processing 300. In conventional method 200, operation 210 involves creating a check. In particular, checks can be written or printed onto paper. The check document contains key fields, namely the Payee name, the Amount, the Date of the payment, the written Amount, and the Signature field. All of this information is provided by the Payor. Additional key fields include the Check Number, the Payor's Bank Routing number, and the MICR (Magnetic Ink Character Recognition) fields, which are typically preprinted on the check documents. In operation 210, a negotiable instrument (i.e., the paper check) is created and ready to present to the Payee.

With further reference to FIG. 5, operation 220 involves delivering the check. Conventionally, the majority of checks are delivered to the Payee through couriers or the US Mail. This is required to move the physical paper checks from one location to another. This process delays the receipt of the payment by several days or longer. Operation 230 entails depositing the check and is the area of check payment processing that has changed the most over recent years. The traditional method of depositing a check into the Payee's account involves physically visiting a bank and making a deposit. In recent years, this process has been automated such that most banks accept deposits electronically. The most common method to make an electronic deposit involves using bank supplied remote deposit capture software, which converts the paper check into an image, formats the information into a bank supported format, and transfers the file(s) to the bank. There are two conventional formats for conversation, namely: (i) using a scanner, and (ii) using a camera (like those found in smart phones).

With continued reference to FIG. 5, operation 240 involves clearing the check. In short, this involves the check being converted into images as per Check Printing for the 21^{st} Century Act (“Check 21”), and being transferred between banks and clearing houses, where they are ultimately presented to the Payor's bank for payment. In some cases, Positive Pay may be used on some business checks. The Positive Pay process can help reduce check fraud by ensuring payments from the Payor's bank only take place for unmodified, preapproved check items. In order to identify the check items to preapproved, the Payor sends to the bank a specially formatted Positive Pay file, which contains key fields for the approved checks. These fields include the Check Number, the Payee name, the Check Date, the Check Amount, and the account it was drawn from.

Still referring to FIG. 5, a method for electronic virtual check payment processing 300, according to an embodiment of the invention, will now be described. Operation 310 involves creating a check. In this eVC payment process, checks are no longer written or printed onto paper. Instead, they are created as images. The check image contains key payment fields such as the Payee name, the Amount, the Date of the payment, the written Amount, and the Signature field, which are all provided by the Payor. Additional key fields are the Check Number, the Payor's Bank Routing number, and the MICR (Magnetic Ink Character Recognition) fields, which are merged with the key payments fields to produce the check image. In operation 310, a negotiable instrument (i.e., the electronic check) is created and ready to present to the Payee, or directly to the Payees bank.

With further reference to FIG. 5, operation 320 involves delivering the check. In the eVC process, the checks are images and therefore can be delivered electronically to the Payee through secure transfer methods, or can be stored and retrieved from an eVC delivery payment website. This process of creating a virtual instant payment can happen in seconds since most Payees consider payments rendered upon receipt of a check. Operation 330 involves depositing the check. In the eVC process, the check images are ready for direct deposit without any scanning or picture taking. The eVC system may include software to directly depositing the eVC payment into the Payee's selected checking account. In some embodiments, traditional recipients have an option to “print” the eVC check and deposit it at the bank, or use scanning Remote Deposit Capture software to deposit the eVC check. In operation 340, the check is cleared. The check clearing process is the same as the traditional model with the added enhancement of an improved process for Positive Pay. More particularly, the eVC system can provide an optional module to create and send Positive Records for all eVC checks to the Payor's bank.

The electronic virtual check payment process described with respect to FIG. 5 can be distinguished from the traditional process in a number of ways. Unlike conventional payment systems, eVC payments are relatively safe, fast, inexpensive, and environmentally friendly. As such, the eVC system modernizes the most trustworthy payment system in the world. In addition, traditional electronic payments require the Payee to share banking information with the Payor, which requires a trusted relationship. Paper checks are also easily forged and altered. By contrast, eVC payments do not require the Payor to know the Payee's banking information, and eVC checks are digitally signed and can contain secure image technology to prevent and detect tampering.

The reliance on US Mail and courier services to deliver checks inhibits the usage of checks for same day or inner day payments for all but a small percentage of check payments. ACH payments take days to process and weeks to set up initially. Wire transfers are fast, but are very costly to use. By contrast, the eVC process delivers images within moments of approvals and can be automatically and instantly deposited in the Payee's bank. Email notifications can be employed to inform the Payee that they have received an eVC and that it has been deposited. As a result, the eVC process provides the same level of service as wire transfers without the associated costs and hassle.

Traditional check payments are estimated to cost over $2.00 per item to the Payor. ACH payments cost as little as $0.15 per item. However, the average cost to implement ACH payments can be over $10,000. By contrast, electronic virtual check uses current processes to create and issue eVC payments, thereby reducing implementation costs to under $100. The cost of eVC payments per item is just a fraction of the per item cost of issuing paper checks and maintaining check printing equipment.

In comparison to traditional check processing, the move to electronic documents and payments is good for the environment. Paper checks consume valuable resources including paper, toner, and the energy to print. ACH payments are commonly followed by remittance information being printed and mailed to the Payee. In contrast, electronic virtual checks provide the ability for payees to view remittance information online.

The United States check payment system is one of the most respected payment systems in the world. It has a long history of successfully providing an easy-to-understand and reliable payment process. The electronic virtual checking systems and methods described herein may utilize the US check payment system. In some embodiments, eVC images are legal drafts in image form as permitted by Check 21. This allows the eVC checks to be completely electronic.

From the viewpoint of the Payee, the electronic virtual checks described herein are an improvement over conventional checks because: (i) the Payee does not have to share their banking information with the Payor in order to receive payments; (ii) the Payee does not have to wait for payment to be posted on their account to confirm the payment; (iii) Payees consider most payments made upon receipt of a check; (iv) costs are greatly reduced compared to accepting bank cards for payments; (v) there is no waiting for the US Mail to deliver payments, and delivery can be performed at any time; and (vi) deposits can be made automatically without clearing delays found in ACH payments.

From the viewpoint of the Payor, eVC are an improvement because: (i) there is a reduced payment cost; (ii) all existing electronic payment methods require new processes and integration to be able to use, whereas eVC uses and enhances the current check printing processes; (iii) eVC provides same day payments, without the hassle and costs of wire transfers; (iv) no printing equipment or supplies are required; (v) payments can be made from any Internet connected device; and (vi) check printing laws are more favorable to Payors with respect to reversals.

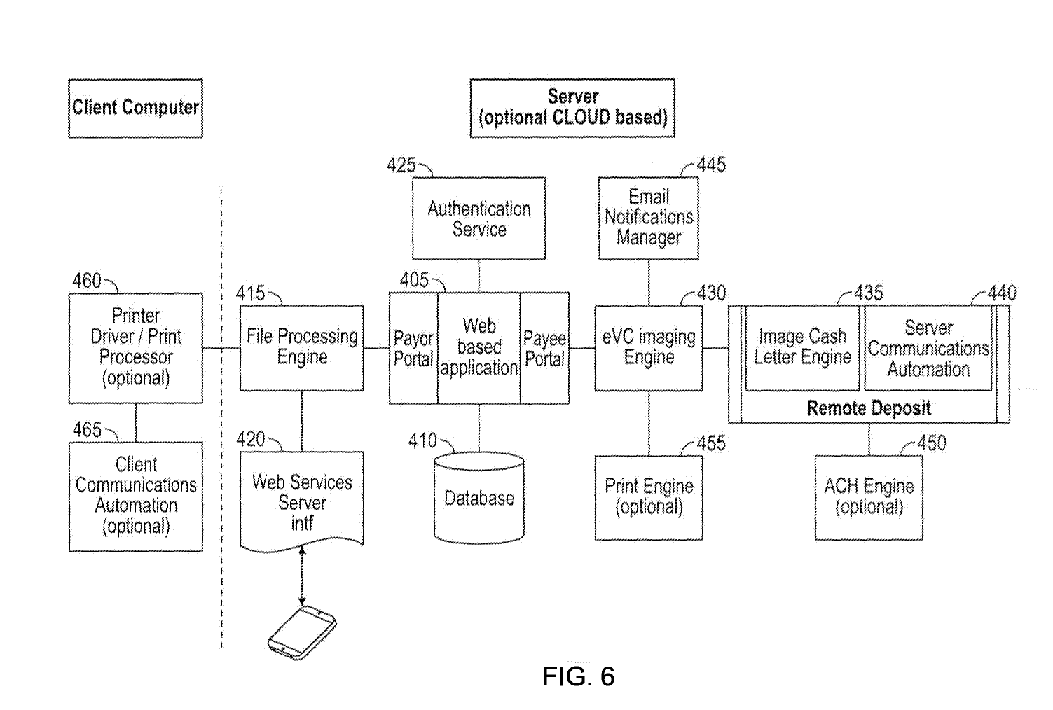

FIG. 6 is a diagram illustrating an electronic virtual check payment system in accordance with an embodiment of the invention. The system 400 includes a web based application 405 (eVC core application) that provides management for Payees and Payors of eVC payments. Payors and Payees can access Payment history, manage accounts, and choose payment options through this portal. Database 410 provides storage of payment transaction data, payment history, and user/account data. Electronic virtual check components or eVC uploaded check images may also be stored here. File processing engine 415 converts payment instruction files from accounting systems, printer drivers, or the Web services interface. Web services server 420 provides API to external applications such as the eVC mobile application, while authentication service 425 provides for management of users, user rights, and other authentication settings to support logging into the Web based application 405.

Still referring to FIG. 6, the eVC imaging engine 430 is used to create eVC checks in real time by combining check background images, signatures, logos, Payor information, Payor bank information, and eVC payment data to include: Payee; Payee Address; Check Number; Amount; Check Date; and MICR line. eVC images can be supported in industry standard image formats, bmp, jpg, and pdf. Image cash letter engine 435 is a component of the Remote Deposit solution. It creates ×9.37 or image cash letter files, with embedded check images, in bank specific formats in order to deposit the images into the bank without using Remote Deposit Capture software from the banks. Server communication automation 440 is another component of the Remote Deposit solution. It is used to automate delivery of image cash letters or ×9.37 files to financial institutions.

With further reference to FIG. 6, email notification manager 445 is used to provide notifications of payments, workflow functions, and error notices. The email notification manager 445 can also communicate via test messaging. The ACH engine 450 can be used by the Payee (Recipient) to convert the eVC to an ACH transfer by providing the file processing to format NACHA formats. The optional print engine 455 can be employed to convert eVC images to printable checks, print system reports, and print specifically formatted archive checks. The printer driver/processor 460 is used to capture checks printed from accounting applications. These checks are not printed and are converted to electronic formatted files ready to upload to the eVC server. Client communication automation 465 is used to automate the upload of files from the client machine into the eVC server.

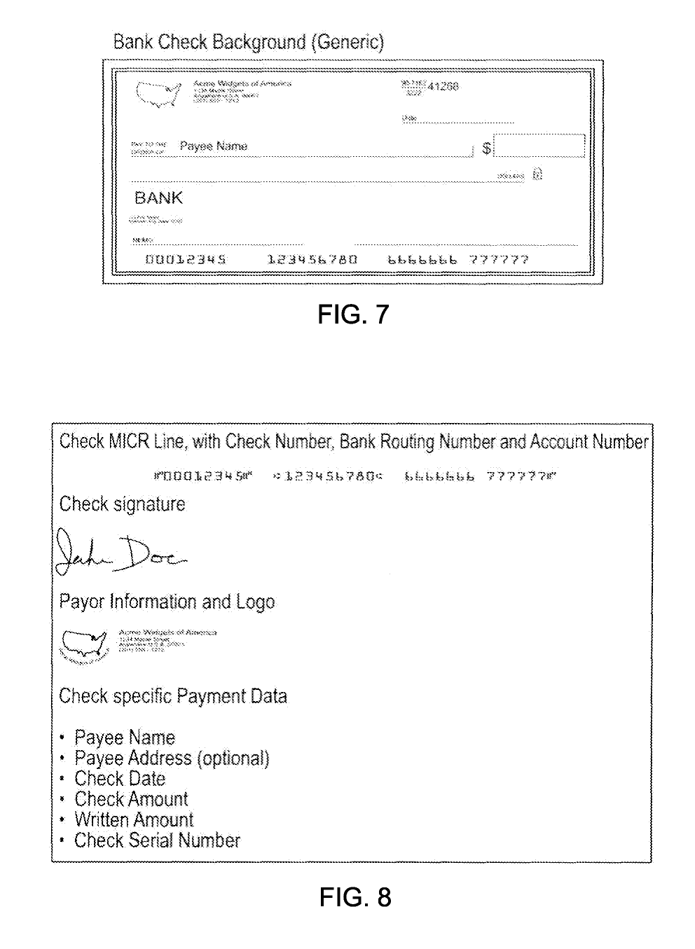

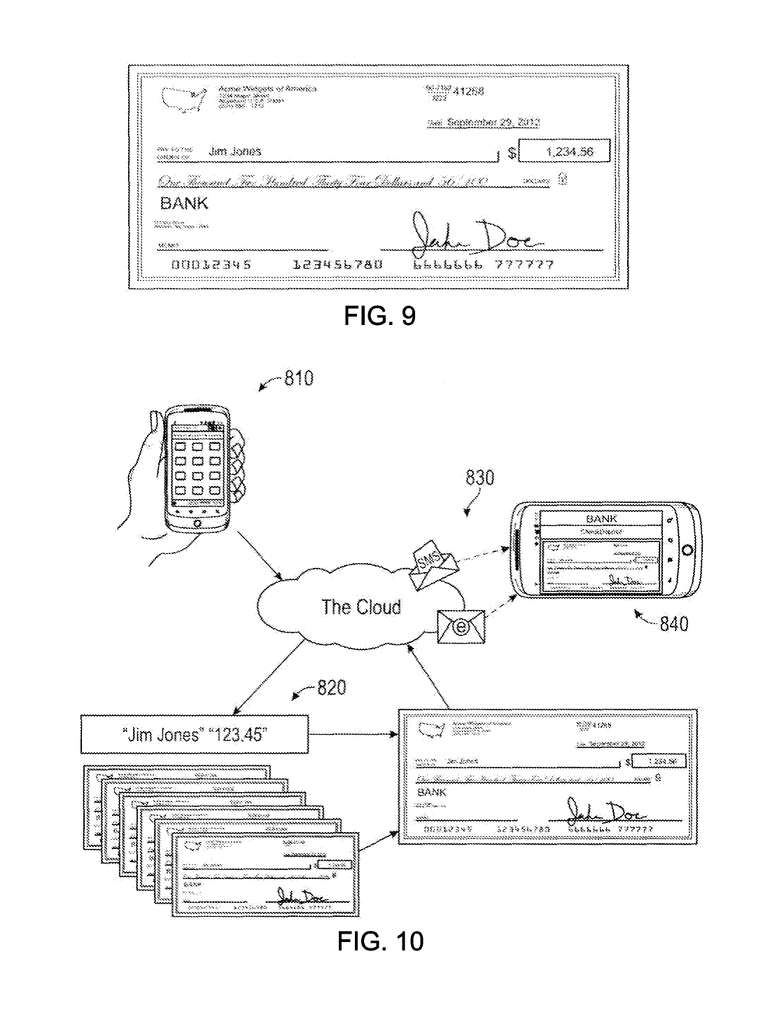

FIG. 7 depicts a bank check 500 having a generic check background, whereas FIG. 8 depicts various information of the Payor including: (i) the check MICR line 610 with the Check Number, Bank Routing Number and Account Number; (ii) the Check Signature; (iii) Payor information and logo; and (iv) check specific payment data including the Payee Name, Payee Address (optional), Check Date, Check Amount, Written Amount, and Check Serial Number. FIG. 9 depicts an electronic virtual check 700 created by merging the bank check 500 of FIG. 7 with the Payor information of FIG. 8, in accordance with the various systems and methods for electronic virtual checks set forth herein.

FIG. 10 is a diagram illustrating a person-to-person payment method and system using the electronic virtual checks described herein. In a first example, a mobile phone user (Payor) enters mobile application payment information to create and send an eVC to the Payor. In operation 810, the Payor enters check payment information into the eVC mobile application and submits the payment to the eVC Payment Platform. In operation 420, the eVC Software merges payment data with next check image to create an eVC image, and then sends the image to the Payee via an MMS message. Operation 430 entails the Payee receiving the MMS message with the eVC image attached. In operation 440, the Payee uses Mobile Remote Deposit software to deposit the eVC into a bank account.

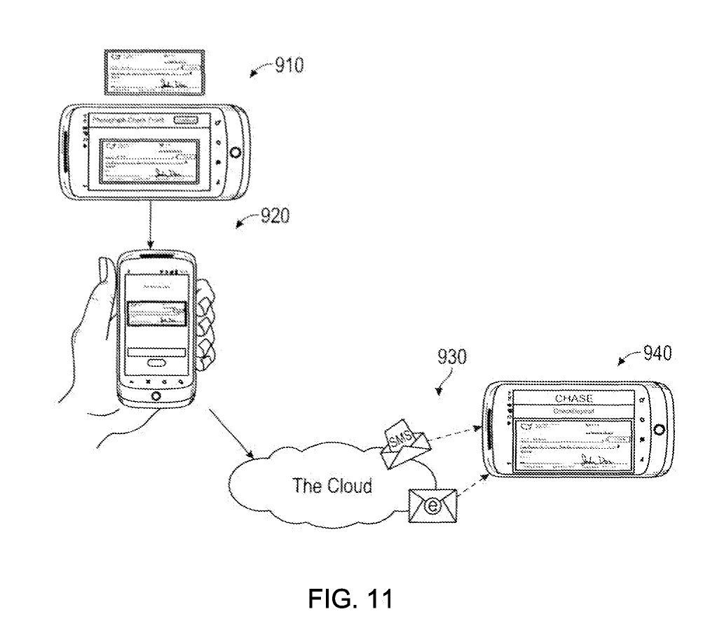

FIG. 11 is a diagram illustrating the conversion of a paper check into an electronic virtual check for delivery and deposit, in accordance with an embodiment of the invention. Operation 910 involves the Payor capturing the paper check with a mobile device camera using eVC mobile device software. In operation 920, the check image is sent to the eVC Payment Platform, which converts the image into an electronic virtual check, as described herein. In operation 930, the eVC image is delivered to Payee's mobile device via an MMS message or email attachment. Operation 940 involves the Payee using Mobile Remote Deposit software to deposit the eVC in a bank.

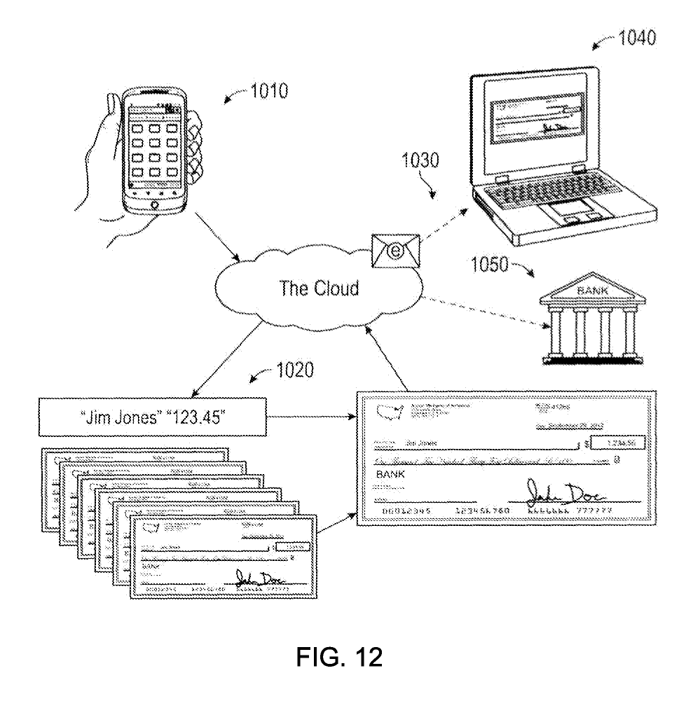

FIG. 12 is a diagram depicting a person-to-business payment method and system using electronic virtual checks, in accordance with an embodiment of the invention. This process involves the mobile phone user (Payor) entering mobile application payment information to create and send an eVC to a business for goods or services. In operation 1010, the Payor enters check payment information into the eVC mobile application, and then submits the payment to the eVC Payment Platform. In operation 1020, the eVC Software merges payment data with the next check image. Operation 1030 entails the eVC software sending a notification via Email to Payee, whereas in operation 1040 the Payee receives the email and clicks the link to log onto the eVC Payment Platform. In operation 1050, the Payee: (i) downloads the eVC image, and then either prints the eVC check to deposit the check traditionally, prints the eVC check to scan into their Remote Deposit Capture software, or uses their Remote Deposit Capture software to upload the eVC image for deposit to the bank; or (ii) authorizes the eVC Payment Platform to deposit the eVC payment directly into their bank account.

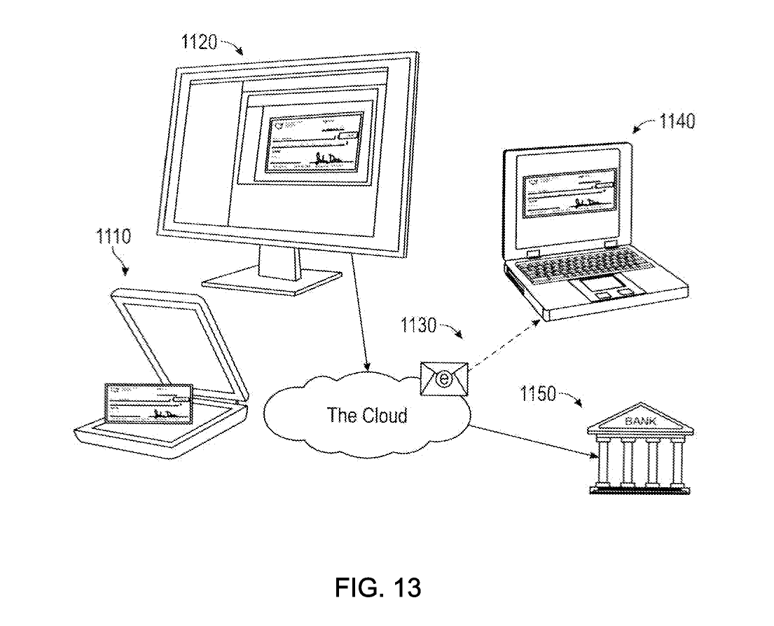

FIG. 13 is a diagram illustrating a business-to-business payment method and system using electronic virtual checks, in accordance with an embodiment of the invention. The process involves the business capturing an existing traditional check with a scanner, which is converted to an eVC and sent to the Cloud eVC application. More particularly, operation 1110 entails the Payor scanning the paper check into a computer. In operation 1120, the Payor uploads the check image to the eVC Payment Platform, while in operation 1130 the eVC software sends a notification via email to Payee. In operation 1140, the Payee receives the email and clicks a link to log onto the eVC Payment Platform. In operation 1150, the Payee: (i) downloads the eVC image, and then either prints the eVC check to deposit the check traditionally, prints the eVC check to scan into their Remote Deposit Capture software, or uses their Remote Deposit Capture software to upload the eVC image for deposit to the bank; or (ii) authorizes the eVC Payment Platform to deposit the eVC payment directly into their bank account.

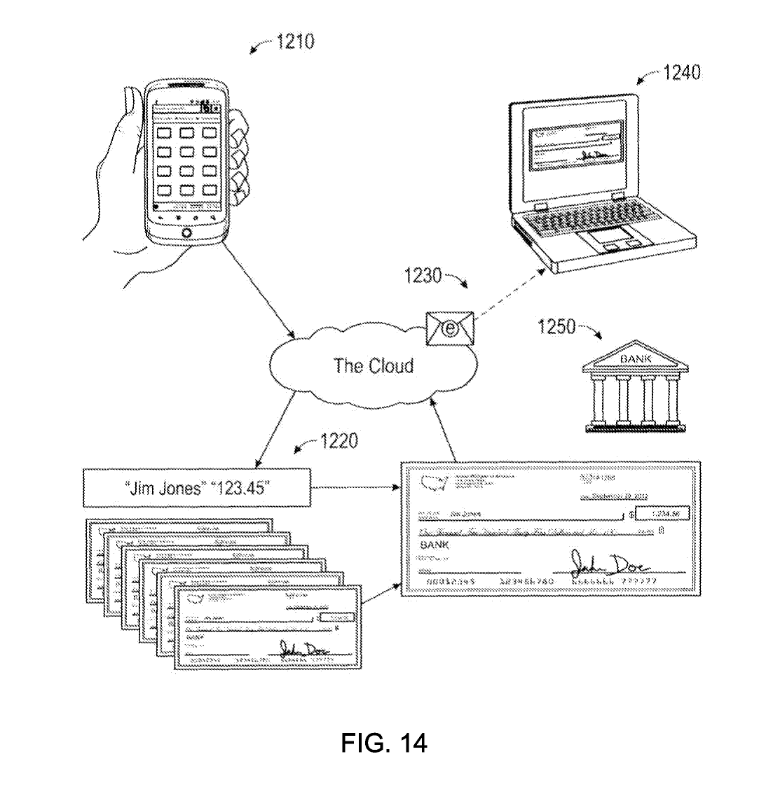

FIG. 14 is a diagram illustrating another business-to-business payment method and system using electronic virtual checks, in accordance with an embodiment of the invention. The process involves the business capturing an existing traditional check with a mobile device, which is converted to an electronic virtual check and sent to the Cloud eVC application for deposit by/for Payees. In operation 1210, the business (Payor) enters check payment information into the eVC mobile application, and then submits the payment to the eVC Payment Platform. Operation 1220 involves the eVC Software merging payment data with the next check image, while operation 1230 involves the eVC software sending a notification via email to the Payee. In operation 1240, the Payee receives the email and clicks a link to log onto the eVC Payment Platform. In operation 1250, the Payee: (i) downloads the eVC image, and then either prints the eVC check to deposit the check traditionally, prints the eVC check to scan into their Remote Deposit Capture software, or uses their Remote Deposit Capture software to upload the eVC image for deposit to the bank; or (ii) authorizes the eVC Payment Platform to deposit the eVC payment directly into their bank account.

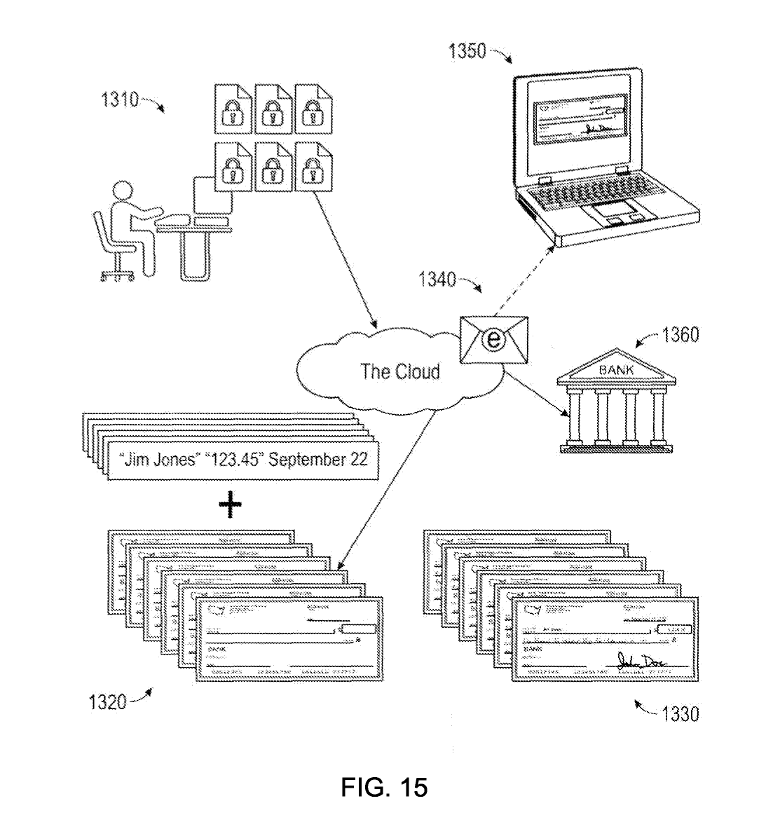

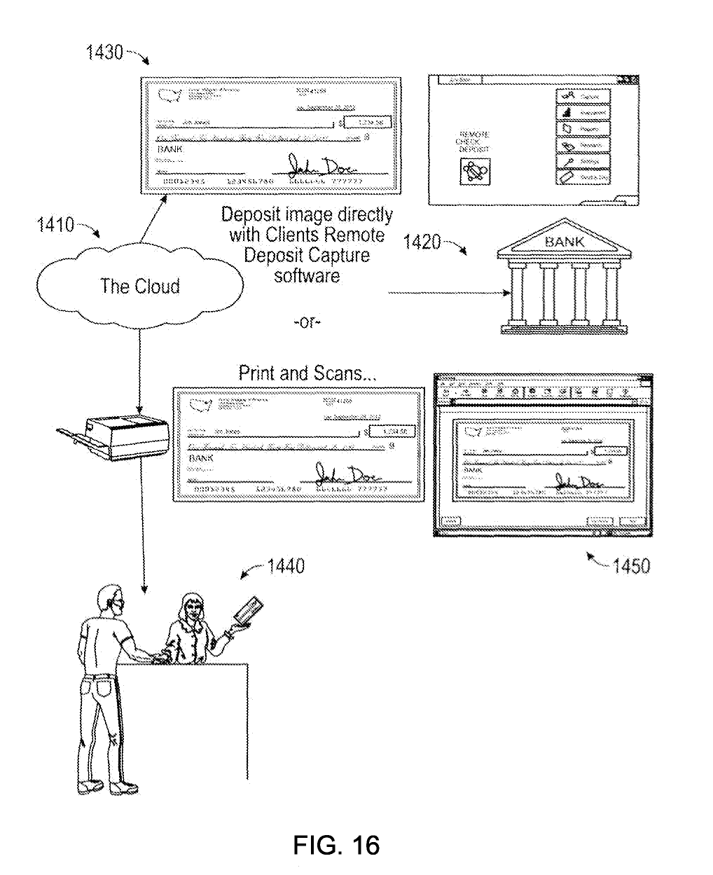

FIG. 15 is a diagram illustrating an additional business-to-business payment method and system using electronic virtual checks, in accordance with an embodiment of the invention. The process involves the business creating a file of check data from a computer accounting system, which is sent to the Cloud eVC application. More particularly, operation 1310 entails the business (Payor) creating a file with check payment information and uploading it into the eVC Payment Platform. In operation 1320, the eVC Software splits the files into individual payments and merges each payment data with the next check image, while in operation 1330 the eVC software sends a notification via email to each Payee. In operation 1340, each Payee receives the email and clicks a link to log onto the eVC Payment Platform. In operation 1350, each Payee: (i) downloads the eVC image, and then either prints the eVC check to deposit the check traditionally, prints the eVC check to scan into their Remote Deposit Capture software, or uses their Remote Deposit Capture software to upload the eVC image for deposit to the bank; or (ii) authorizes the eVC Payment Platform to deposit the eVC payment directly into their bank account.

FIG. 16 is a diagram illustrating a system and method for depositing Payee eVCs, in accordance with an embodiment of the invention. Specifically, in operation 1410, each Payee receives an email containing notification of the eVC payment and clicks the link to log onto the eVC Payment Platform. Next, the Payee chooses and performs one of the following options: (i) operation 1420, wherein the Payee authorizes the eVC Payment Platform to deposit the eVC payment directly into their bank account (if Payee's bank option enabled in Payment Platform); (ii) operation 1430, wherein the Payee uses their Remote Deposit Capture software to upload the eVC image for deposit to the bank directly from the eVC supplied check image; (iii) operation 1440, wherein the Payee downloads the eVC image and Prints a paper check to deposit the check traditionally; and (iv) operation 1450, wherein the Payee downloads the eVC image and prints a paper check to scan into their Remote Deposit Capture software, which will deposit the check into the bank.

The above-described embodiments may rely one or more of the following technologies: (i) electronic digital signature management; (ii) payor payment authorization signature; (iii) payee deposit authorization signature; and (iv) alteration protection.

In various embodiments of the invention, eVC images do not exist before they are downloaded or deposited. Rather, they are created in real time from unique payment information stored in a database. This prevents breaches of security including the stealing, altering or examining of eVC payments.

Some embodiments of the invention involve the creation of electronic checkbooks (eVirtual checks) for individuals and businesses. Such checkbooks act as a repository of virtual electronic images that are verifiable as unique for each check image, and can be used only once. These virtual images can be created through software “on the fly” when an order for eVirtual checks is received, e.g., by merging standard or generic check images with unique Payor information, the assignment of the check numbers, the addition of any special images, and the creation of the MICR line. In some cases, these images are imported into eVirtual checks by scanning or another conventional method. Once in the Cloud, the eVirtual checks can be inventoried, audited and tracked. Each electronic virtual check has a unique check number that is correlated to one bank account at one financial institution. Check images are either pending, voided, or issued.

Further embodiments of the invention involve the deployment of, or integration with, a Mobile Payment application to capture and/or issue virtual checks. Various embodiments also involve the deployment of an Internet based Cloud application and database for processing of check requests and delivering check images. Additional embodiments involve the deployment of an Internet based Cloud portal application to create and manage eVirtual checks, and eVirtual wallets.

Various embodiments of the invention entail the deployment of imaging software to overlay check detail information and signatures with eVirtual checks. The software can create and manage a unique digital signature for the image file to help detect tampering. Further embodiments involve the deployment of a unique image watermark to overlay on the checks to identify the source of the image and protect tampering of key fields. In some configurations, the Cloud builds check images in real time such that there is no actual check image as the source image.

In some embodiments of the invention, the accounting application optionally outputs the check data to a printer driver, wherein the system captures the printer driver data and suppresses printing. The printer driver data is then reformatted and sent to the Cloud. Alternatively, the printer driver data can be sent to the Cloud without formatting.

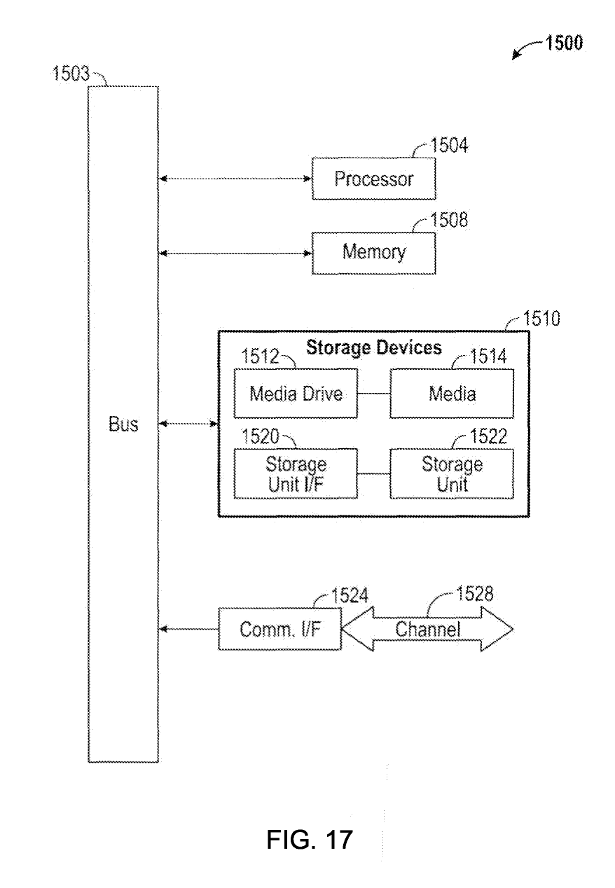

As used herein, the term “module” might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 17. Various embodiments are described in terms of this example-computing module 1500. After reading this description, it will become apparent to a person skilled in the relevant art how to implement embodiments of the application using other computing modules or architectures.

Referring now to FIG. 17, computing module 1500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 1500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1500 might include, for example, one or more processors, controllers, control modules, or other processing devices, such as a processor 1504. Processor 1504 might be implemented using a general-purpose or special-purpose processing engine such as, for example, a microprocessor, controller, or other control logic. In the illustrated example, processor 1504 is connected to a bus 1503, although any communication medium can be used to facilitate interaction with other components of computing module 1500 or to communicate externally.

Computing module 1500 might also include one or more memory modules, simply referred to herein as main memory 1508. For example, preferably random access memory (RAM) or other dynamic memory, might be used for storing information and instructions to be executed by processor 1504. Main memory 1508 might also be used for storing temporary variables or other intermediate information during execution of instructions to be executed by processor 1504. Computing module 1500 might likewise include a read only memory (“ROM”) or other static storage device coupled to bus 1503 for storing static information and instructions for processor 1504.

The computing module 1500 might also include one or more various forms of information storage mechanism 1510, which might include, for example, a media drive 1512 and a storage unit interface 1520. The media drive 1512 might include a drive or other mechanism to support fixed or removable storage media 1514. For example, a hard disk drive, a floppy disk drive, a magnetic tape drive, an optical disk drive, a CD, DVD or Blu-ray drive (R or RW), or other removable or fixed media drive might be provided. Accordingly, storage media 1514 might include, for example, a hard disk, a floppy disk, magnetic tape, cartridge, optical disk, a CD, DVD or Blu-ray, or other fixed or removable medium that is read by, written to or accessed by media drive 1512. As these examples illustrate, the storage media 1514 can include a non-transitory computer readable medium having computer executable program code embodied thereon.

In alternative embodiments, information storage mechanism 1510 might include other similar instrumentalities for allowing computer programs or other instructions or data to be loaded into computing module 1500. Such instrumentalities might include, for example, a fixed or removable storage unit 1522 and an interface 1520. Examples of such storage units 1522 and interfaces 1520 can include a program cartridge and cartridge interface, a removable memory (for example, a flash memory or other removable memory module) and memory slot, a PCMCIA slot and card, and other fixed or removable storage units 1522 and interfaces 1520 that allow software and data to be transferred from the storage unit 1522 to computing module 1500.

Computing module 1500 might also include a communications interface 1524. Communications interface 1524 might be used to allow software and data to be transferred between computing module 1500 and external devices. Examples of communications interface 1524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1524 might typically be carried on signals, which can be electronic, electromagnetic (which includes optical) or other signals capable of being exchanged by a given communications interface 1524. These signals might be provided to communications interface 1524 via a channel 1528. This channel 1528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1508, storage unit 1520, media 1514, and channel 1528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1500 to perform features or functions of the present application as discussed herein.

While various embodiments of the present application have been described above, it should be understood that they have been presented by way of example only, and not of limitation. Likewise, the various diagrams may depict an example architectural or other configuration for the disclosure, which is done to aid in understanding the features and functionality that can be included in the disclosure. The application is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present application. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to process a check payment from a user using a debit card by:
receiving debit card information from the user;
sending the information to a payment platform via a network connection;
exchanging the debit card information with a financial services provider and receiving a response providing information to enable the creation of a check, including bank routing number, bank name, and user account number;
storing the information in a database and
creating a check image including the bank account, bank routing number, bank name, payee name, and payee signature.

2. The computer readable medium of claim 1, wherein receiving debit card information from the user comprises the user swiping the debit card on a card reader terminal.

3. The computer readable medium of claim 2, wherein receiving debit card information from the user further comprises the user entering a personal identification number after swiping the debit card.

4. The computer readable medium of claim 1, wherein the response further includes the payee name and a validation if the supplied amount is more than the funds available.

5. The computer readable medium of claim 1, further comprising using the data stored in the database to make determinations on the likelihood of fraud.

6. The computer readable medium of claim 1, further comprising imaging the bank account information, bank routing number and check number at the bottom of the check to produce a MICR line.

7. The computer readable medium of claim 1, further comprising depositing the check image into the merchants account electronically.

8. The computer readable medium of claim 1, where the user is prompted to write their signature on a digitization pad, touch screen, or mobile PDA such that the digital signature is imaged on the check.

9. The computer readable medium of claim 8, wherein the signature is stored in the database and is keyed to the debit card and account information.

10. The computer readable medium of claim 1, wherein receiving the debit card information comprises the user entering the information into a payment application.

11. The computer readable medium of claim 1, where the user's signature is not required and the payment is processed as a draft check.

12. The computer readable medium of claim 1, wherein the user's signature is previously stored in the database such that it is not required to be resubmitted for an online payment and the payment is processed as a normal check.

13. A method for causing a computing device to process a check payment from a user using a debit card, comprising:
receiving debit card information from the user;
sending the information to a payment platform via a network connection;
exchanging the debit card information with a financial services provider and receiving a response providing information to enable the creation of a check, including bank routing number, bank name, and user account number;
storing the information in a database and
creating a check image including the bank account, bank routing number, bank name, payee name, and payee signature.

14. The computer readable medium of claim 13, wherein receiving debit card information from the user comprises the user swiping the debit card on a card reader terminal.

15. The computer readable medium of claim 14, wherein receiving debit card information from the user further comprises the user entering a personal identification number after swiping the debit card.

16. The computer readable medium of claim 13, wherein the response further includes the payee name and a validation if the supplied amount is more than the funds available.

17. The computer readable medium of claim 13, further comprising using the data stored in the database to make determinations on the likelihood of fraud.

18. The computer readable medium of claim 13, further comprising imaging the bank account information, bank routing number and check number at the bottom of the check to produce a MICR line.

19. The computer readable medium of claim 13, further comprising depositing the check image into the merchants account electronically.

20. The computer readable medium of claim 13, wherein the user is prompted to write their signature on a digitization pad, touch screen, or mobile PDA and the digital signature is imaged on the check.

21. The computer readable medium of claim 13, wherein the signature stored in the database is keyed to the debit card and account information.

22. The computer readable medium of claim 13, wherein receiving the debit card information comprises the user entering the information into a payment application.

23. The computer readable medium of claim 13, wherein the user's signature is not required and the payment is processed as a draft check.

24. The computer readable medium of claim 13, wherein the user's signature is previously stored in the database such that it is not required to be resubmitted for an online payment and the payment is processed as a normal check.
